(19) United States
(12) Patent Application Publication
(10) Pub. No.: US 2005/0215928 A1
(43) Pub. Date: Sep. 29, 2005

(54) Back muscle rollover

(75) Inventors: Carolyn Leah Banks, Carlsbad, NM (US); Leilani Susan Buxton, Hatfield, AR (US); Robert Loyd Kennedy JR., Carlsbad, NM (US); Misty Dawn Kennedy, Carlsbad, NM (US)

Correspondence Address: Carolyn Leah Banks, 1708 Jewel, Carlsbad, NM, 88220, US

(73) Assignee: Leahs.us, LLC, Carlsbad, NM (US)

(21) Appl. No.: 10/808,088

(22) Filed: Mar. 23, 2004

(51) Int. Cl. A61H 15/00

(52) U.S. Cl. 601/112; 601/121; 601/122

(57) ABSTRACT

Our invention provides a new concept for massage, acupressure, and vertebral alignment. The device is simple but the method of using the device is a new application for a roller invention. Most back-massage devices and spinal alignment devices apply pressure perpendicular to the spine and on both sides of the spine, and some include a groove to accommodate the spine itself. Many acupressure devices are simply single-point-of-contact devices. In contrast, our invention applies pressure parallel and adjacent to the spine and along the length of the device; is used with a rocking motion in a single axis over the length of the device with the device used as a fulcrum; is padded to limit damage to the spinous processes and to increase comfort during use; and requires the user to relax somewhat while giving themselves a back massage, which provides additional benefits and safety during the invention's use. In addition, each Rollover is sold with a set of copyrighted 2003 instructions; can be used in a variety of locations; is inexpensive; is truly portable; and can be used in a cooperative effort between healthcare professionals and individual users.

### FIELD OF THE INVENTION

Because the backache is such a common syndrome for homo-sapiens, much time and effort, and therefore expense, has gone into developing methods to relieve those backaches. The field of endeavor of this patent application is for a device and method of providing back massage, acupressure stimulation, and, to a limited degree, intervertebral or intersegmental extension.

### BACKGROUND OF THE INVENTION

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

A backache is a common syndrome characterized by pain and tenderness emanating from the components of a person's spinal support system. The pain is experienced deep under the skin, is not localized, and is characteristically of a dull, aching quality. The pain is almost always found with mechanical dysfunction of neuromuscular tissues. The progressive pain syndrome has a deleterious effect on the spinal support system and the person to whom the painful back belongs. This results in inhibition of the spinal extensor muscles, or if very painful, a co-contraction of flexor and extensor trunk muscles resulting in muscle spasms.

Often an individual's only recourse is to seek medical attention when the symptoms become severe. However, by that time, muscles may have atrophied; posture may have suffered to compensate for the painful sections of the spine; and the individual may require extensive remedial action to recover form the progressive pain syndrome. The best available recourse might be a method of relieving backaches before they become severe. However, some of the products available to relieve backaches require significant financial investments and are not portable and others could be perceived as a possible cause of additional pain because of their extreme appearance. For instance, some products are made of metal with knobs, knurls, sharp edges, etc. Other products are large devices meant for traction or manipulation of the spine. In addition, our research has found none that are designed for use parallel to the spine, but instead are used perpendicular to the spine, applying pressure equilaterally. In contrast, our invention is inexpensive, soft to the touch, includes extensive directions and cautions for use, requires relaxation to use properly, allows infinite adjustment of pressure applied against the device, and is very portable.

One common cause of today's backaches is that so many people have sedentary occupations. Some employment requires sitting for most of an eight hour period, with little time available for exercise. Other employment requires significant strain resulting in tired and stiff muscles and vertebral misalignment. This invention was designed to relieve those minor to moderate backaches.

The object of our invention is to provide a simple device that an individual can use in the privacy of their home or office; while either lying supine on a firm surface or pressing against a vertical surface; to give themselves either a complete back massage or simply massage an area of their back that is currently causing pain; and possessing the additional benefit of micro-adjusting the pressure applied to the massaged areas.

The old saying that “Necessity is the Mother of Invention” was certainly true in the development of our invention. The first-named inventor suffers from backaches caused by mild scoliosis. She was desperately searching for back-pain relief that was always available when needed because time available to seek chiropractic care was significantly constrained. Toward that end, she began using a wooden dowel to massage her back along the lamina grooves. When she shared her discovery with the other inventors, they found the dowel was simply too painful to use because it was rigid. They suggested the dowel needed padding to protect the spine; therefore, padding was added to the hard core. In addition, we have developed an assortment of diameters to allow persons with a variety of body builds to benefit from the Rollover. A specific method for using the Rollover was developed (See claim 3) and it was soon discovered that written instructions were necessary as were warnings and notes for use.

All six inventors have materially participated in the development of the final Rollover product and instructions for its use over a period of six months from Feb. 1 to Aug. 30, 2003. During August and September, the first Rollovers were assembled and some materials were changed. Instructions were developed and copyrighted Sep. 24, 2003 with the original date of publication being Jun. 2, 2003. The first Rollover was sold Sep. 29, 2003; therefore, it is our understanding that we need to begin the patent process before that date.

As part of the development effort, all of the inventors successfully use the Rollover for back-muscle massages. We have shown the Rollover to friends and other relatives, including sharing the instructions for use, and most of them agree that it does provide relief. We have sold a few of the Rollovers and have had no complaints from the purchasers. Therefore, we believe the product should be available to provide pain relief from simple back-muscle tension, but is not meant as a medical device without supervision by a medical professional.

Before investing a significant amount of time and capital in manufacturing the Rollovers, we decided to seek patent development assistance. We hired a firm to do a “Patentability Search” for our the device using the original name of “Muscle Roller”. The search was completed and reported on Sep. 5, 2003. The search firm focused their “body of art” search for similar “exercise roller” products including “single rollers used for exercising purposes” and “variations of exercise rollers”. The exercise roller results included three single roller design patents and two utility patents. In addition, one design patent and one utility patent were found as variations of exercise rollers. “The search was conducted in class 601, subclasses 112 and 122, and Design class 24, subclasses 211 and 212”.

The patentability search firm report of single roller patents included D201, 598, which is apparently a fluted metal cylinder with a handle on each end. Its description includes little more than the drawings. The second patent was D249,551, which is similar to the first one but seems to have smaller flutes that also seem to be beveled around the circumference of the device at equal intervals along the “working” surface of the device. In contrast to our invention, both these devices seem to be designed for someone to use on another individual because of the handles and neither is padded. In comparison, the first is a massage device while the other is a “therapeutic apparatus”.

The third device reported by the firm is U.S. Pat. No. 268,524. The patent claim states that it is an “ornamental design for an acupressure instrument for applying rolling pressure to the human body”. In contrast to the Rollover, it is obviously used by a practitioner on a patient and could be used on any part of the body.

The search firm reported that U.S. Pat. No. 3,419,268 would preclude us from obtaining a patent on the Rollover. This device included various layers of padding over a cylindrical core of approximate diameter of 1¼“. However, this patented device was designed specifically to “improve the posture”, “maintain the normal curvature of the spine at the-small-of-the-back and lower spine”, “act as a cushion while sitting”, and is primarily an exercise device and cushion. In contrast to the Rollover, the length of this device is placed perpendicular to the spine for exercise and cushion purposes and the Rollover is used parallel to the spine as a massage device—two completely different usages. The core of this device is the same diameter as the largest Rollover core, however, the Rollover padding only adds ⅜″ to its diameter while the finished diameter of this device is approximately 5″ and therefore the two devices are not comparable in appearance and construction.

Another patent reported in the Search results is U.S. Pat. No. 3,645,256. The roller(s) are made with alternating discs of metal and “semihard rubber or other material having a suitable degree of resilience”which are then inserted over a “bolt”with one threaded end to allow firmness adjustments. The user lies down on the device and “moves his body transversally to the roller axis”. Individual rollers of this device can be used with considerable effort to keep both the shoulders and hips lifted from the “floor or other smooth, flat, hard surface”, which, according to the patent documents, could provide more exercise benefit than massage benefit. This “massage-exerciser device” can also consist of a “plurality of said rollers” to provide a more relaxing massage. In contrast, our invention is used parallel to the spine instead of perpendicular; the massaging is done by rotating over its axis; our invention requires little effort to use instead of exerting the effort to either stay balanced on one roller or continuously move up and down their device; ours is not adjustable; ours is padded for protection of the user; our invention is only a single roller; and our invention's single purpose is for massage. Therefore, this device is not comparable to our invention.

The first variation of exercise rollers was U.S. Pat. No. D418,227, which is an “ornamental design for a portable back massager”. It appears to be two rollers with holes in the length into which some sort of dowel is inserted. Apparently the rollers rotate over the “dowels” and the dowels are perpendicularly connected at each end by a larger “dowel” which could be used as both handle and a method of maintaining the distance between the rollers to allow the user to roll over the device or have the device used on them by another person. In contrast to our invention, the rollers do not seem to be padded. Their device could be used parallel with the spine only if the person was lying still or moving the hips and/or shoulders in a side-to-side motion. It is probably generally used perpendicular to the spine. In comparison, it is used only for massage and it is also portable like our invention but probably much larger. It could also be used when the person was standing against a vertical surface. Therefore, overall this device is also not actually comparable.

One of the variations includes a “core with a foam cover (U.S. Pat. No. 6,312,401)”; however, this patent is for a “collapsible cervical traction device” that includes nine foam-covered rollers in a frame, onto which a user lays down. According to the Abstract for the device, it is designed to “align the neck of a person using the cervical traction device and also functions to elongate the spacing between the neck vertebrae and hold them in traction when the neck support assembly pivots forwardly and downwardly”. In addition, the Background for the device includes the statement that it was designed for “an individual to place their neck in traction for short periods of time”. In contrast our invention allows the user to massage all the muscles that support their spine and was not intended to provide any form of traction. Therefore, this device is also not comparable to our invention.

In retrospect, the specifications we provided to the search firm were probably too broad in scope; however, we wanted to be certain to include enough breadth of scope to cover all permutations we conceived during the development phase of this first product. In addition, the Rollover is not an exercise device—it is a massage device.

Further Internet research for “massage devices” discovered one patent that described a “muscular therapy treatment apparatus for spine muscles (U.S. Pat. No. 6,036,791)”, that included references to other similar patents. The U.S. classes of that patent included 606/204, 601/134, and 606/240 and their “Field of Search” included 606/204,237,238,241,242,201 and 601/134. We believe this device is similar to our invention in the benefits it provides to the user, plus both are designed for “self-treatment”. This device was designed for “muscular therapy treatment” and to “relax and lengthen the muscles”, plus it “simulates the type of deep concentrated pressure applied by muscular therapist hands to the seven layers of muscles attached to the lamina groove”. In comparison to this device, we believe our invention provides a similar but less intense benefit to the user and both require active involvement by the user. In contrast, our invention can be used to massage the entire spine; the other device includes “sharp edges” which probably provide a more intense treatment than the Rollover with the padded surfaces (the smallest diameter Rollover is about ¾″ when compressed”) as compared to the “approximate one-half inch maximum width and depth” reported in Claim 1 of U.S. Pat. No. 6,036,719 (deemed necessary by the inventor to massage all seven layers of spine-support muscles and to provide “automatic vertebrae alignment”); our invention is a flat-sided cylinder as compared to “essentially convex” (claims 2, 5, 6, 9, 12, 13) or arched (arcuate) surfaces designed into their device; and our invention has foam-type padding while their apparatus has “sharp edges” (claim 1); and finally, their device is not as portable as our invention. This device is somewhat comparable is usage, but not in construction or appearance.

Three other patents that include back massaging rollers were similar to each of the others. U.S. Pat. No. 6,419,650 includes 6 rollers, U.S. Pat. No. 1,572,794 included 4 rollers, and U.S. Pat. No. 6,071,253 included one large roller. In contrast to our invention, all three required the user to place the rollers perpendicular to the spine and all had at least one roller with a groove to accommodate the spine. None were padded.

Two patents on single rollers also had grooves to accommodate the spine. U.S. Pat. No. 6,129,687 could also be filled with hot, cold, or hot and cold liquids and was somewhat adjustable. In contrast to our invention, their device would best be used perpendicular to the spine and its surface could include an assortment of dimples, ridges, protrusions, or ribs instead of a smooth padding. U.S. Pat. No. 5,170,778 is also designed for use on a firm surface but in contrast to our invention it is designed to work perpendicular to the spine and is not padded. In comparison, it appears this patent is also designed to massage the lamina groove similar to our invention.

However, because the “Patentability Search” and the subsequent Internet search found no similar usages of a foam-covered core using a single-roller design as a massage device, we believe we in fact have a basis for a utility patent on our invention.

### BRIEF SUMMARY OF THE INVENTION

The present invention provides relief from mild backaches and could be used with professional medical assistance on more severe pain. It is inexpensive and portable because of the invention's small size and simple structure. The invention can be used almost anywhere there is sufficient floor space or access to a vertical surface that can withstand the pressure applied against the device. Most other devices apply massaging pressure on the spine, the lamina groove, and spinal support structure using devices placed perpendicular to the spine. These devices apply pressure concurrently to a limited number of vertebrae, depending upon the inventions circumference. In contrast, the user of our invention can provide massage pressure along its entire 5-10″ length plus they have control over the pressure applied against their lamina groove. The variation in core diameter from ½″ to 1½″ allows users to select the diameter that best suits their personal needs and/or body build. Because this device is so simple, the method of using the invention is a significant factor in the device's patentability. Each Rollover includes a copy of the ©2003 Carolyn Leah Banks method description, cautions, and instructions.

### BRIEF DESCRIPTION OF THE SEVERAL VIEWS OF THE DRAWING

FIG. 1 is a perspective view of the invention. Because the foam surface is ground smooth, but is slightly textured similar to suede, the outside surfaces along the length of the invention are not actually clean and crisp lines. In addition, the ends of the foam are beveled and are shown as a dark ring around the end plug or rod end.

FIG. 2 is an end view of the invention showing the beveled surface and the end plug or rod end. FIG. 3 show a lengthwise view of the invention. The core extends approximately 1/16″ out from each end of the foam sleeve to allow the sleeve to be securely glued onto the core and the beveled foam surfaces at the ends are gently rounded.

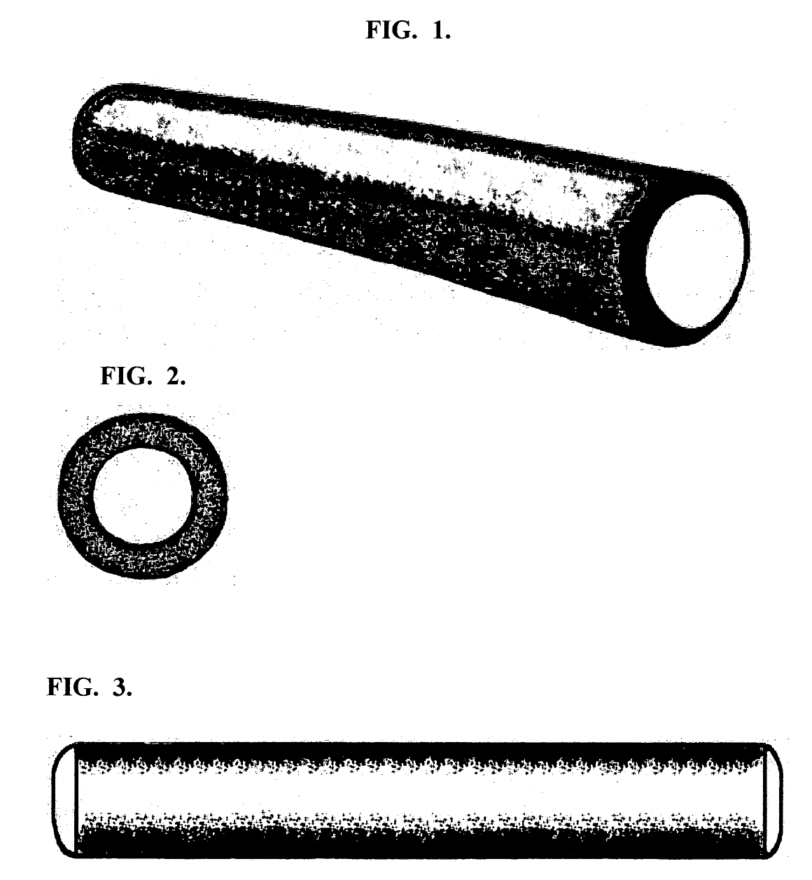

### DETAILED DESCRIPTION OF THE INVENTION

This invention consists of a simple tube or rod, approximately 5 to 10″ in length and ½″ to 1½″ in diameter, used as a core and slipped inside a foam-type sleeve with a ½ to ½ inside diameter and a wall thickness of approximately 3/16″ for a total diameter of approximately ¾″ to 1⅞″. Caps are used to finish the ends of tubes. The rods are slightly ground on the ends to minimize injury. The foam sleeves have a ground exterior finish, are slightly beveled on the edges, and are made of a durable material. The sleeves are glued to the core at each end to prevent slippage of the sleeve away from the core's end. The method of using this invention includes detailed instructions, notes, and cautions (©2003 by Carolyn Leah Banks). Because the device is simple in design and construction, the usage method is a critical factor in differentiating this device as a new invention.

Method of using the device:
a. The device is used parallel to and pressed against one side of the spine in the lamina groove and then moved to the other side at the same location. The supine individual places the device parallel to their spine, relaxes, and gently rolls over the device, using it like a fulcrum.
b. A complete massage includes using the device on each side of four locations along the spine, starting at the pelvic girdle or lower end of the spine.
c. The foam-type material covering the device increases the individual's comfort and ability to relax during its use.
d. Pressure used against the device and the time spent massaging at each location generally depends on the pain at each location.
e. The user should select the diameter of the device that provides the most benefit and comfort for their body type. This is the most critical issue because the smaller the diameter of the device, the deeper the massage, acupressure, and intervertebral or intersegmental extension treatment provided to the user. However, if the device is too small in diameter, contact pressure against the device is diminished and if it is too large, it is not comfortable to use because of excessive pressure.
f. The length of the device provides concurrent contact with one side of a minimum four vertebrae, which spreads the pressure applied to all contacting vertebrae across the length of the device, thus limiting the device's ability to mobilize individual vertebrae. If a vertebra requires only that limited amount of pressure for realignment, then that vertebra might slip gently back into proper alignment.

1. We claim as our invention a cylindrical hard inner core made of metal, plastic, PVC or other firm or semi firm material; the core can either hollow or solid; it must be covered by a foam-type sleeve with an O.D. of ¾ to 1¾″ to provide protective padding over the core; that the core is 5 to 10″ in length and varies from ½″ to 1½″ in outside diameter; that the variation in diameters allows users to select one of several sizes that best meets their personal massage requirements; and that the core is the instrument for applying massage and/or acupressure.

2. We claim as our invention the right to use a flexible or semi rigid core in the Rollover when necessary because of abnormalities in some individual's spinous processes.

3. We claim as our invention the specific method of placing a foam-covered tube or rod parallel to the spine and between a firm surface and the spine as a deep massage and/or acupressure device; that the device is specifically designed to massage the seven layers of muscles supporting the spine; the method as described will simultaneously provide massage and acupressure to the muscles of the spinous processus along some or all of the length of the device; and that the written instructions describing the complete method have a 2003 copyrighted date.

4. We claim as our invention the specific steps included in the massage and/or acupressure method for using the device including: (1) lay supine with knees up and feet comfortably apart and placed parallel to one another on the floor or other firm or semi-firm surface (preferably carpeted for comfort); (2) roll slightly to one side, placing the device parallel with the spine and against the lower spine at the pelvic girdle; (3) rolls gently over the device by alternately pushing up with one leg and the hip attached to that leg from the floor, while lowering the opposite hip toward the firm surface, rocking back and forth over the device adjusting pressure against the device by lifting or pushing with the hips, legs, shoulders and abdominal muscles; (4) move the device to the other side and repeat; (5) move the device to the lower ribcage and repeat the rolling massage on both sides; (5) move the device to the upper ribcage and repeat rolling massage on both sides; (6) and finally move the device to the cervical area, placing the device one to two inches below the base of the skull and massaging both sides, and additional pressure can be applied against the cervical neck area by placing the head slightly off a step to the point where the individual's elbows can be dropped over the edge of the step.

5. We claim as our invention that our device reduces pain and tension in the spinous processes during and after use and the relaxation required for the method enhances the massage benefits by requiring pressure to be applied to the spinous processes.

6. We claim as our invention that the device can also be used for massage and/or acupressure by placing the device between a wall (or some vertical surface) and the user's back and rotating the user's body in a similar to the seesaw movement as described in claim 3.

7. We claim the right to mount the Rollover onto a frame, which can then be mounted onto a vertical surface to allow the user to massage specific areas along their spine when that user cannot easily use a supine position on a horizontal surface.

8. We claim as our invention that the device can either be used for a complete back massage as described in claim 4 or it can be used only on specific painful sections of the spine, using the same methods as described in claim 4 for other uses as described in claims 6 and 7.

9. We claim as our invention that the foam padding added to the firm core allows the user to deep-massage their spinuous processes while somewhat protecting the structural components of their spinous processes from bruising when used as described in claims 4, 6, 7 and 8.

10. We claim as our invention that because the method concurrently provides pressure against several vertebrae, it gently lengthens foreshortened support muscles in the lamina groove, thereby allowing a vertebra to automatically align with its adjacent vertebrae.
